(19) United States
(12) Patent Application Publication
(10) Pub. No.: US 2026/0176155 A1
(43) Pub. Date: Jun. 25, 2026

(54) POSITIVE ELECTRODE ACTIVE MATERIAL, POSITIVE ELECTRODE, SECONDARY BATTERY, AND METHOD FOR PRODUCING POSITIVE ELECTRODE ACTIVE MATERIAL

(71) Applicant: MURATA MANUFACTURING CO., LTD., Kyoto (JP)

(72) Inventors: Daisuke ITO, Kyoto (JP); Yasuhiro IKEDA, Kyoto (JP)

(21) Appl. No.: 19/543,557

(22) Filed: Feb. 18, 2026

Related U.S. Application Data
(63) Continuation of application No. PCT/JP2024/027363, filed on Jul. 31, 2024.

(30) Foreign Application Priority Data
Sep. 27, 2023 (JP) 2023-166476

(51) Int. Cl. C01G 53/502; H01M 4/02; H01M 4/525

(52) U.S. Cl. CPC C01G 53/502; H01M 4/525; C01P 2002/85; C01P 2004/04; C01P 2004/61; C01P 2006/40; H01M 2004/021; H01M 2004/028

(57) ABSTRACT

Provided is a positive electrode active material, a positive electrode, or a secondary battery having high charge load characteristics. The positive electrode active material includes a lithium complex oxide having a layered rock-salt structure. The lithium complex oxide contains lithium, a metal element including at least one of cobalt and nickel, and potassium. A ratio of a substance amount of potassium contained in the lithium complex oxide to a substance amount of the metal element included in the lithium complex oxide is 0.0005 or more and 0.03 or less. In the lithium complex oxide, potassium is distributed so as to extend in a direction intersecting a <001> direction of the layered rock-salt structure.

### CROSS REFERENCE TO RELATED APPLICATIONS

The present application is a continuation of International Patent Application No. PCT/JP2024/027363, filed on Jul. 31, 2024, which claims priority to Japanese Patent Application No. 2023-166476, filed on Sep. 27, 2023, the entire contents of which are incorporated herein by reference.

### BACKGROUND

The present disclosure relates to a positive electrode active material, a positive electrode, a secondary battery, and a method for producing a positive electrode active material.

A positive electrode is disclosed including active material containing lithium nickel oxide having a layered rock-salt structure.

### SUMMARY

The present disclosure relates to a positive electrode active material, a positive electrode, a secondary battery, and a method for producing a positive electrode active material.

However, in the positive electrode active material described in the Background section, there is a possibility that the charge load characteristics are deteriorated depending on the distribution of potassium in the layered rock-salt structure.

The present disclosure has been devised in view of the above problems, and relates to provide a positive electrode active material, a positive electrode, or a secondary battery having high charge load characteristics according to an embodiment.

A positive electrode active material according to an embodiment of the present disclosure contains a lithium complex oxide having a layered rock-salt structure, in which the lithium complex oxide contains lithium, a metal element containing at least one of cobalt and nickel, and potassium, a ratio of a substance amount of potassium contained in the lithium complex oxide to a substance amount of the metal element contained in the lithium complex oxide is 0.0005 or more and 0.03 or less, and in the lithium complex oxide, potassium is distributed so as to extend in a direction intersecting a <001> direction of the layered rock-salt structure.

A positive electrode according to an embodiment of the present disclosure contains the positive electrode active material.

A secondary battery according to an embodiment of the present disclosure includes the positive electrode, a negative electrode, and an electrolyte.

A method for producing a positive electrode active material according to an embodiment of the present disclosure is a method for producing a positive electrode active material, the positive electrode active material containing a lithium complex oxide having a layered rock-salt structure, the method including: a step of firing a precursor containing lithium, at least one of cobalt and nickel, and potassium at 200° C. or higher and lower than 600° C. to prepare the lithium complex oxide.

According to the present disclosure, it is possible to provide a positive electrode active material, a positive electrode, or a secondary battery having high charge load characteristics.

### BRIEF DESCRIPTION OF THE FIGURES

FIG. 1 is a sectional view illustrating an example of a secondary battery according to an embodiment.

FIG. 2 is an enlarged sectional view illustrating a part of a cross section of an electrode assembly according to FIG. 1.

FIG. 3A is a view showing a TEM observation image of a positive electrode active material according to an example of an embodiment.

FIG. 3B is a view showing an EDX mapping image of potassium in a region according to FIG. 3A.

FIG. 4A is a view showing a TEM observation image of a positive electrode active material according to a comparative example of the first embodiment.

FIG. 4B is a view showing an EDX mapping image of potassium in a region according to FIG. 4A.

FIG. 5 is a cutaway view illustrating another example of the secondary battery according to an embodiment.

FIG. 6 is a schematic sectional view taken along line VI-VI in FIG. 5.

### DETAILED DESCRIPTION

Hereinafter, the present disclosure will be described in further detail including with reference to the figures according to an embodiment. Note that the present disclosure is not limited thereby. The numerical values include rounded-off ranges.

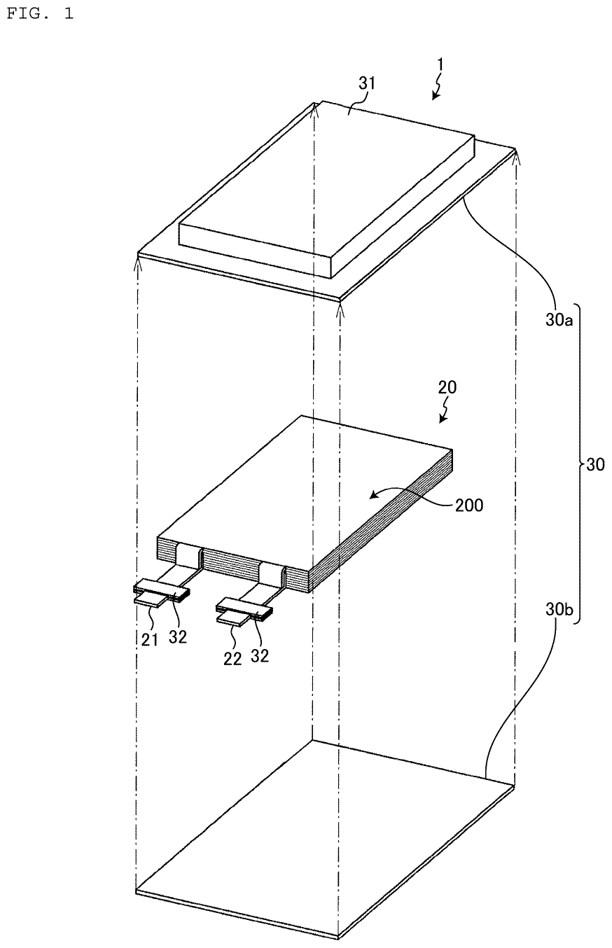

FIG. 1 is a sectional view illustrating an example of a secondary battery according to a first embodiment. A secondary battery 1 illustrated in FIG. 1 is a laminate type lithium ion secondary battery. As illustrated in FIG. 1, the secondary battery 1 includes a battery element 20, an exterior member 30, and an adhesive member 32.

The battery element 20 is provided inside the exterior member 30. As illustrated in FIG. 1, the battery element 20 includes an electrode assembly 200, a positive electrode lead 21, and a negative electrode lead 22. The positive electrode lead 21 is a terminal extended from a positive electrode 210 described later to the outside of the exterior member 30. That is, the positive electrode lead 21 is a terminal serving as a plus electrode of the secondary battery 1. In FIG. 1, the positive electrode lead 21 is provided on an end surface of the electrode assembly 200. The negative electrode lead 22 is a terminal extended from the inside of a negative electrode 220 described later to the outside of the exterior member 30. That is, the negative electrode lead 22 is a terminal serving as a minus electrode of the secondary battery 1. In FIG. 1, the negative electrode lead 22 is provided on an end surface of the electrode assembly 200. Details of the electrode assembly 200 will be described later.

The exterior member 30 is a case in which the battery element 20 is housed. The exterior member 30 includes two exterior sheets 30a and 30b. The exterior sheets 30a and 30b each include an insulating layer, a metal layer, and an outermost layer. In the example of FIG. 1, a recess 31 is provided in the exterior sheet 30a. As a result, the battery element 20 is housed in the recess 31, and the peripheral edges of the exterior sheets 30a and 30b are bonded, whereby the battery element 20 is housed in the exterior member 30.

The exterior sheets 30a and 30b have a structure in which an insulating layer, a metal layer, and an outermost layer are stacked in this order from the inside, namely, from the side where the battery element 20 is provided, and stuck by lamination processing or the like. The insulating layer of each of the exterior sheets 30a and 30b is formed of, for example, a resin such as polyethylene, polypropylene, modified polyethylene, modified polypropylene, or a polyolefin resin containing ethylene or propylene as a monomer. As a result, the exterior sheets 30a and 30b can lower the moisture permeability of the secondary battery 1, and can improve the airtightness. The metal layer of each of the exterior sheets 30a and 30b is a plate material or a foil material of metal such as aluminum, stainless steel, nickel, or iron. The outermost layer may be formed of an arbitrary material, but is preferably formed of, for example, a material having high strength against breakage, piercing, or the like, such as a resin similar to that of the insulating layer, and nylon.

The adhesive member 32 is a member for making the exterior member 30 hermetic. The adhesive member 32 is provided each between the exterior member 30 and the positive electrode lead 21 and between the exterior member 30 and the negative electrode lead 22. The material of the adhesive member 32 preferably has a close contact property to the positive electrode lead 21 and the negative electrode lead 22. For example, when the positive electrode lead 21 and the negative electrode lead 22 are each formed of a metal material, a polyolefin resin such as polyethylene, polypropylene, modified polyethylene, and modified polypropylene is used as the adhesive member 32. As a result, the adhesive member 32 can keep the gap between the exterior member 30 and the positive electrode lead 21 and the gap between the exterior member 30 and the negative electrode lead 22 hermetic, so that the interior of the exterior member 30 can be made airtight.

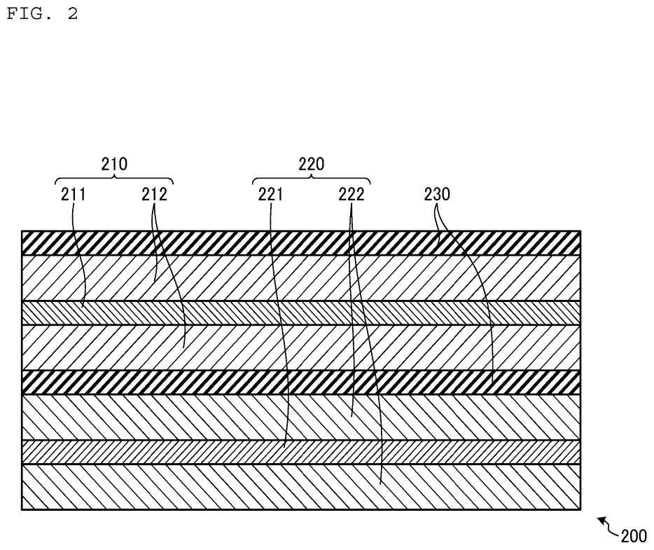

FIG. 2 is an enlarged sectional view illustrating a part of a cross section of the electrode assembly according to FIG. 1. More specifically, FIG. 2 is a sectional view illustrating a part of one layer of the positive electrode 210 and one layer of the negative electrode 220 in the electrode assembly 200. As shown in FIG. 2, the electrode assembly 200 includes the positive electrode 210, the negative electrode 220, and a separator 230. In the secondary battery 1, the electrode assembly 200 has a structure in which the positive electrode 210 and the negative electrode 220 are stacked in a thickness direction with the separator 230 interposed therebetween. The electrode assembly 200 includes the positive electrode 210 and the negative electrode 220, each of which is a layered member for a charge-discharge reaction of the secondary battery 1 according to the first embodiment.

The positive electrode 210 includes a positive electrode current collector 211 and positive electrode active material layers 212. In the positive electrode 210, the positive electrode current collector 211 is stacked between the positive electrode active material layers 212.

The positive electrode current collector 211 is a conductive layer and, for example, an aluminum foil, a stainless steel foil, or the like can be used. In the example of FIG. 1, the shape of the positive electrode current collector 211 is a rectangular sheet having a protrusion on the positive electrode lead 21 side in plan view in the thickness direction. The protrusion of the positive electrode current collector 211 is connected to the positive electrode lead 21.

The positive electrode active material layer 212 is a layer containing a positive electrode active material. The positive electrode active material layer 212 contains a positive electrode active material, a positive electrode binder, and a positive electrode conductive aid. The positive electrode active material layer 212 is not limited to the materials described above, and may further contain, for example, a dispersant.

The positive electrode active material contains a lithium complex oxide. The lithium complex oxide contains lithium, a metal element containing at least one of cobalt and nickel, and potassium. In the first embodiment, the lithium complex oxide has a composition formula represented by Li₁₋ₓKₓNi_{1-y}Co_{y}O_{2-z}, and satisfies 0.0005≤x≤0.03, 0≤y≤1, and −0.1≤z≤0.2. Here, x in the composition formula is a ratio of a substance amount of potassium contained in the lithium complex oxide to a substance amount of the metal element contained in the lithium complex oxide. When x is 0.0005 or more, charge-discharge load characteristics can be improved. When x is 0.03 or less, a decrease in charge-discharge characteristics can be suppressed. Note that, in the first embodiment, the positive electrode active material is particles formed of a lithium complex oxide, but is not limited thereto, and may be, for example, a layer formed of a lithium complex oxide.

The values of x and y can be measured by energy dispersive X-ray spectroscopy (EDX). More specifically, a sample prepared by processing the cross section of the positive electrode active material or the positive electrode active material layer 212 is observed, and a rectangular region having a side of 50 nm or more and 200 nm or less, which is a region separated inward by 150 nm or more from the surface of the lithium complex oxide, is selected, and the contents of Ni, Co, and K are measured by EDX. In the measurement, the contents of Ni, Co, and K are measured in five regions not overlapping each other, and the molar ratio of the content of K to the total of the contents of Ni and Co in each region is calculated. Thus, by calculating the arithmetic average of the molar ratio of the content of K to the total of the contents of Ni and Co in each region, x can be calculated as the ratio of the substance amount of K to the total of the substance amounts of Ni and Co, and y can be calculated as the ratio of the substance amount of Co to the total of the substance amounts of Ni and Co.

The value of z is calculated by the following method. First, for the sample prepared by processing the cross section of the positive electrode active material or the positive electrode active material layer 212, the composition ratio 1−y:y of Ni and Co is measured by scanning electron microscope (SEM)-EDX or inductively coupled plasma (ICP). Then, the valences of Ni and Co are calculated by X-ray absorption spectroscopy (XAS) using synchrotron radiation X-rays. Then, it is determined whether or not Formula (1) using the composition ratio 1−y:y of Ni and Co is satisfied.

$$2.6 \leq ( valence of Ni ) \times ( 1 - y ) + ( valence of Co ) \times y \leq 3.2 \qquad ( 1 )$$

When Formula (1) is satisfied, 2−z can be obtained by the following Formula (2) with Li and K as monovalent ions and O as divalent anions.

$$2 - z = [ \text{} 1 \times ( 1 - x ) + 1 \times x + ( valence of Ni ) \times ( 1 - y ) + ( valence of Co ) \times y ] / 2 \qquad ( 2 )$$

When Formula (1) is not satisfied, it is assumed that Li is largely lost due to charge and discharge, and z is set to 0.

The lithium complex oxide has a layered rock-salt structure. In other words, at least a part of the lithium complex oxide has a layered rock-salt structure. As a result, the volume energy density can be improved.

The crystal structure of the lithium complex oxide can be specified by a transmission electron microscope (TEM) or scanning transmission electron microscope (STEM). More specifically, the sample prepared by processing the cross section of the positive electrode active material or the positive electrode active material layer 212 is observed, and the crystal structure of the lithium complex oxide can be specified by performing crystal structure analysis using a TEM or STEM on a measurement point separated inward by 150 nm or more from the surface of the lithium complex oxide. At this time, when the crystal structure belonging to the space group R-3m can be confirmed at least at one measurement point, it can be said that the lithium complex oxide has a layered rock-salt structure.

Hereinafter, the distribution of potassium (K) in the lithium complex oxide will be described in detail.

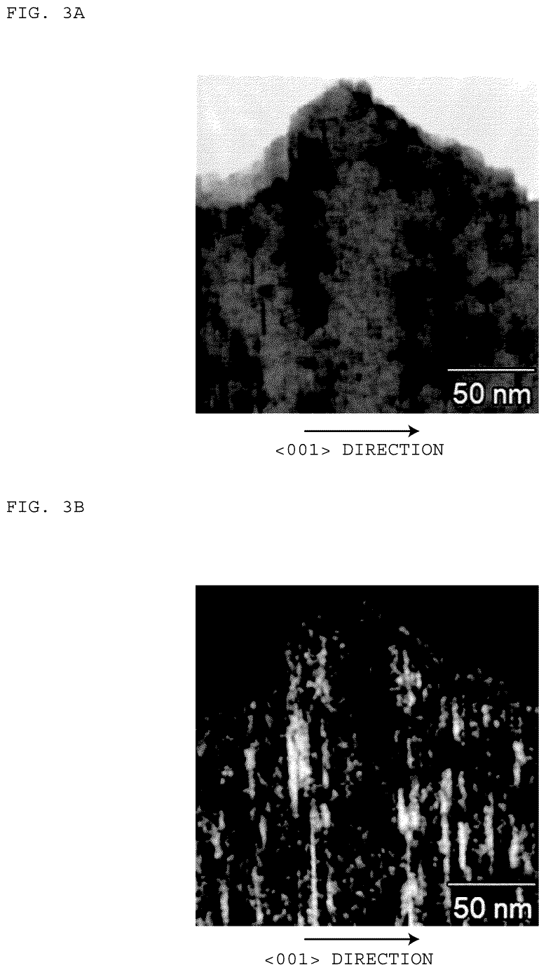

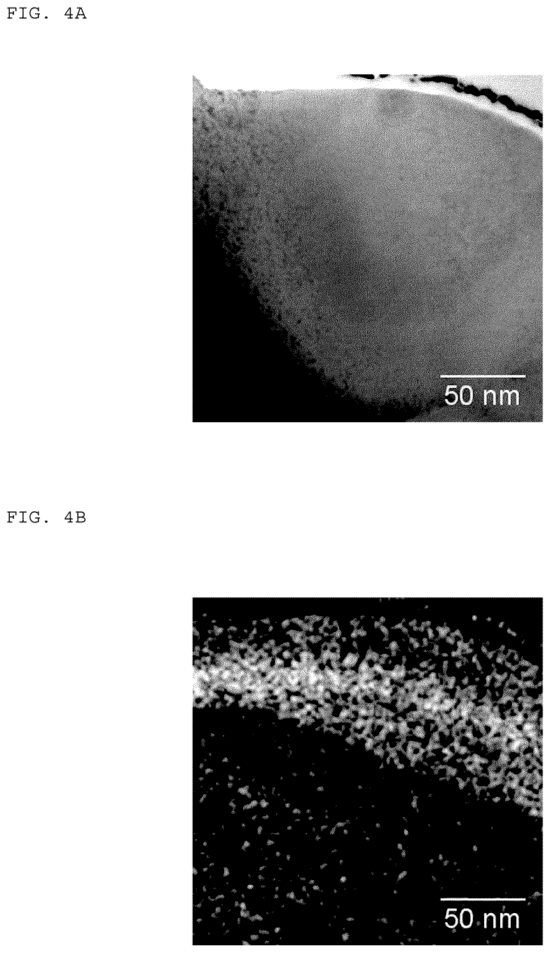

FIG. 3A is a view showing a TEM observation image of a positive electrode active material according to an example of the first embodiment. FIG. 3B is a view showing an EDX mapping image of potassium in a region according to FIG. 3A. FIG. 4A is a view showing a TEM observation image of a positive electrode active material according to a comparative example of the first embodiment. FIG. 4B is a view showing an EDX mapping image of potassium in a region according to FIG. 4A. Regions appearing in black or dark gray in FIGS. 3A and 4A are regions occupied by the lithium complex oxide. Regions appearing white in FIGS. 3B and 4B are regions in which potassium is distributed. Here, the positive electrode active material according to FIGS. 3A and 3B is a positive electrode active material according to Example 1 described later, and the positive electrode active material according to FIGS. 4A and 4B is a positive electrode active material according to Comparative Example 2 described later.

As shown in FIG. 3B, in the lithium complex oxide according to the first embodiment, potassium is distributed so as to extend in a direction intersecting a <001> direction of the layered rock-salt structure. In the present disclosure, the <001> direction of the layered rock-salt structure refers to a direction equivalent to a Miller index of <001> among normal directions of crystal planes of the layered rock-salt structure.

The distribution of potassium in the layered rock-salt structure can be measured by TEM-EDX or STEM-EDX. More specifically, the sample prepared by processing the cross section of the positive electrode active material or the positive electrode active material layer 212 is observed, and a rectangular region having a side of 50 nm or more and 200 nm or less, which is a region separated inward by at least 150 nm from the surface of the lithium complex oxide, is selected, and the <001> direction of the layered rock-salt structure is specified by analysis of the crystal orientation using a TEM or STEM. Next, an EDX mapping image of potassium is acquired in the region, and a region in which potassium is distributed is specified.

Here, as shown in FIG. 3B, when the distribution of potassium is linear in at least a partial region and extends in the direction intersecting the <001> direction of the layered rock-salt structure, it can be said that potassium is distributed so as to extend in the direction intersecting the <001> direction of the layered rock-salt structure. Whether or not the distribution of potassium is linear is determined by the following method. First, the EDX mapping image of potassium is binarized. The threshold value for binarization is an average value of the maximum pixel value and the minimum pixel value in the EDX mapping image. When the shape of the region having the larger pixel value is a shape having a length in one direction, it can be said that the distribution of potassium is linear. On the other hand, as shown in FIG. 4B, when potassium is dispersed in a dotted form, since the distribution of potassium is not linear, it cannot be said that potassium is distributed so as to extend in the direction intersecting the <001> direction of the layered rock-salt structure.

In the lithium complex oxide according to the first embodiment, insertion and extraction of lithium ions are performed in the direction intersecting the <001> direction of the layered rock-salt structure. As shown in FIG. 3B, by arranging potassium having an ionic radius larger than that of Li ions in the direction intersecting the <001> direction of the layered rock-salt structure, the interoxygen distance in the <001> direction increases. As a result, as compared with a case where potassium is dispersed and distributed as shown in FIG. 4B, the restraint of lithium ions by oxygen is suppressed, the diffusion rate of lithium ions can be improved, and the charge-discharge load characteristics can be improved.

When the positive electrode active material contains particles formed of a lithium complex oxide, the particle size is preferably 10 μm or more. In the present disclosure, the particle size refers to a median diameter (D₅₀ diameter). Since the positive electrode active material according to the first embodiment has high charge-discharge load characteristics even when the crystal particles are increased in size, the charge capacity can be improved while suppressing a decrease in performance and a decrease in volume energy density due to an increase in surface area.

When the positive electrode active material contains particles formed of a lithium complex oxide, the particle size may be 100 μm or less. In this case, battery characteristics during high-speed charging and discharging can be improved.

The positive electrode binder contained in the positive electrode active material layer 212 may be an arbitrary material, and contains, for example, one or more of synthetic rubber and a polymer compound. Examples of the synthetic rubbers include a styrene-butadiene-based rubber, a fluorine-based rubber, and ethylene propylene diene. Examples of the polymer compound include a polyvinylidene fluoride (PVdF) and a polyimide.

The positive electrode conductive aid contained in the positive electrode active material layer 212 may be an arbitrary material, and contains, for example, carbon. Examples of the carbon include graphite, carbon black, acetylene black, and ketjen black. However, the positive electrode conductive aid contained in the positive electrode active material layer 212 is not limited to those as long as it is a material having conductivity, and may be a metal material, a conductive polymer, or the like.

The negative electrode 220 includes a negative electrode current collector 221 and negative electrode active material layers 222. In the negative electrode 220, the negative electrode current collector 221 is stacked between the negative electrode active material layers 222.

The negative electrode current collector 221 is a conductor, and for example, a copper foil or the like can be used. In the example of FIG. 1, the shape of the negative electrode current collector 221 is a rectangular sheet having a protrusion on the negative electrode lead 22 side in plan view in the thickness direction. The protrusion of the negative electrode current collector 221 is connected to the negative electrode lead 22.

The negative electrode active material layer 222 is a layer containing a negative electrode active material. The negative electrode active material layer 222 is not limited to be formed of only the negative electrode active material, and may contain, for example, a conductive aid and a binder.

The negative electrode active material refers to a reducing agent capable of absorbing and desorbing charge carriers of the secondary battery 1 via a charge-discharge reaction, such as a carbon material, a metal, a metalloid, an alloy or compound of silicon, or an alloy or compound of tin (Sn).

Examples of the negative electrode active material containing silicon include a simple substance of silicon, an alloy of silicon, and a compound of silicon. Examples of the alloy of silicon that can be used as the negative electrode active material include one containing at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as a second constituent element other than silicon. Examples of the compound of silicon that can be used as the first negative electrode active material include compounds of silicon containing oxygen (O) or carbon (C), such as silicon oxide (SiOₓ) and silicon carbide (SiC), and may contain the above-described second constituent element in addition to silicon. The negative electrode active material may be doped with Li. When the negative electrode active material is SiOₓ, the SiOₓ is preferably pre-doped with Li by doping it with Li in a production step of the negative electrode 220. This makes it possible to reduce the irreversible capacity of SiOₓ as the negative electrode active material. The negative electrode active material may be a composite of Si and another substance such as carbon, or a composite of a Si alloy and another substance such as carbon. In this case, the irreversible capacity can be reduced. In addition, it is preferable that the particle surface of the negative electrode active material is partly or fully coated with carbon. Thus, the electron conductivity of the particle surface of the negative electrode active material can be improved.

Examples of the carbon material that can be used as the negative electrode active material include mesocarbon microbeads (MCMB), artificial graphite, natural graphite, non-graphitizable carbon, and graphitizable carbon. More specifically, the material that can be used as the negative electrode active material includes pyrolytic carbons, cokes, glassy carbon fibers, organic polymer compound fired bodies, activated carbon, and carbon blacks. Examples of the cokes include pitch coke, needle coke, and petroleum coke. The organic polymer compound fired body is a substance obtained by firing a polymer compound such as a phenol resin and a furan resin at an appropriate temperature to carbonize.

The negative electrode active material is not limited to those recited above, and may contain other negative electrode active materials, for example, a material capable of occluding and releasing lithium, such as an alloy or compound of a metal or metalloid, or an alloy or compound of tin (Sn). Examples of the metal and the metalloid that can be used as the negative electrode active material specifically include tin (Sn), lead (Pb), aluminum (Al), indium (In), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Among them, germanium, tin, and lead are preferable. Tin is more preferable because tin has a great ability to occlude and release lithium and a high energy density can be attained.

Examples of the alloy of tin that can be used as the negative electrode active material include alloys including at least one from the group consisting of nickel, copper, iron, cobalt, manganese, zinc, indium, silver, titanium, germanium, bismuth, antimony, and chromium as the second constituent element other than tin. Examples of the compound of tin that can be used as the negative electrode active material include those including oxygen or carbon, and the compound of tin may include the above-mentioned second constituent elements in addition to tin.

The separator 230 is a membrane that insulates the positive electrode 210 from the negative electrode 220. The separator 230 is provided between a main surface of the positive electrode 210 and a main surface of the negative electrode 220 so as to keep the positive electrode 210 and the negative electrode 220 from coming into direct contact with each other. In the example of FIG. 1, the shape of the separator 230 is a rectangular sheet in plan view in the thickness direction.

Preferably, the material of the separator 230 is electrically stable, is chemically stable against the positive electrode active material, the negative electrode active material, and the electrolytic solution, and has an insulating property. For the separator 230, a layer formed of a polymer nonwoven fabric, a porous film, or glass or ceramic fibers can be used, for example. The material of the separator 230 more preferably includes a porous polyolefin film. Thus, the safety of the battery can be improved by the effect of short circuit prevention and the effect of shutdown.

The separator 230 is impregnated with the electrolytic solution. In the example of FIG. 1, the electrolytic solution is filled into a space in the exterior member 30. The electrolytic solution is a non-aqueous electrolytic solution containing an electrolyte salt and a solvent for dissolving the electrolyte salt.

Examples of the electrolyte salt include lithium salts such as lithium perchlorate (LiClO₄), lithium hexafluorophosphate (LiPF₆), lithium tetrafluoroborate (LiBF₄), lithium bis(trifluoromethanesulfonyl)imide (LiN(SO₂CF₃)₂), lithium bis(pentafluoroethanesulfonyl)imide (LiN(SO₂C₂F₅)₂), and lithium hexafluoroarsenate (LiAsF₆).

Examples of the solvent include non-aqueous solvents including lactone-based solvents such as γ-butyrolactone, γ-valerolactone, δ-valerolactone, and ε-caprolactone, carbonate-based solvents such as ethylene carbonate, propylene carbonate, butylene carbonate, vinylene carbonate, dimethyl carbonate, ethyl methyl carbonate, and diethyl carbonate, ether-based solvents such as 1,2-dimethoxyethane, 1-ethoxy-2-methoxyethane, 1,2-diethoxyethane, tetrahydrofuran, and 2-methyltetrahydrofuran, nitrile-based solvents such as acetonitrile, sulfolane-based solvents, phosphoric acids, phosphoric acid ester solvents, and pyrrolidones.

The electrolytic solution may further contain an additive such as a fluorinated carboxylic acid ester, a sulfonic acid ester, a sulfonic acid anhydride, and a carboxylic acid anhydride as an additive.

Although the battery according to the first embodiment has been described above, the secondary battery according to the first embodiment is not limited to that illustrated in FIG. 1. Hereinafter, other examples will be described, but configurations similar to those in FIGS. 1 and 2 are denoted by reference symbols, and description thereof will be omitted.

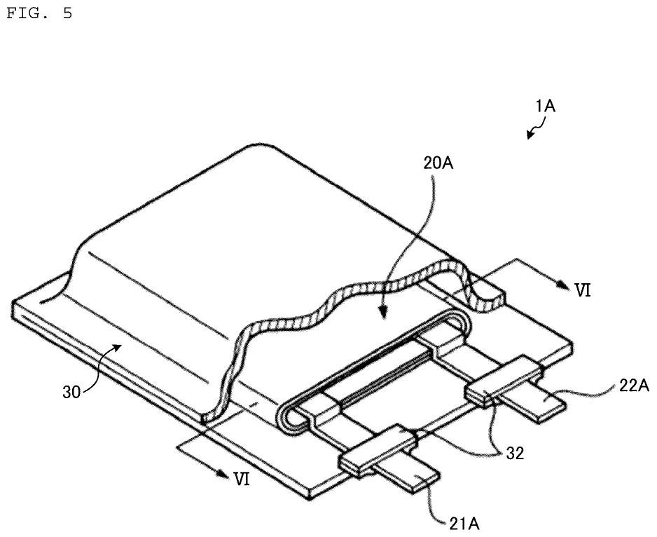

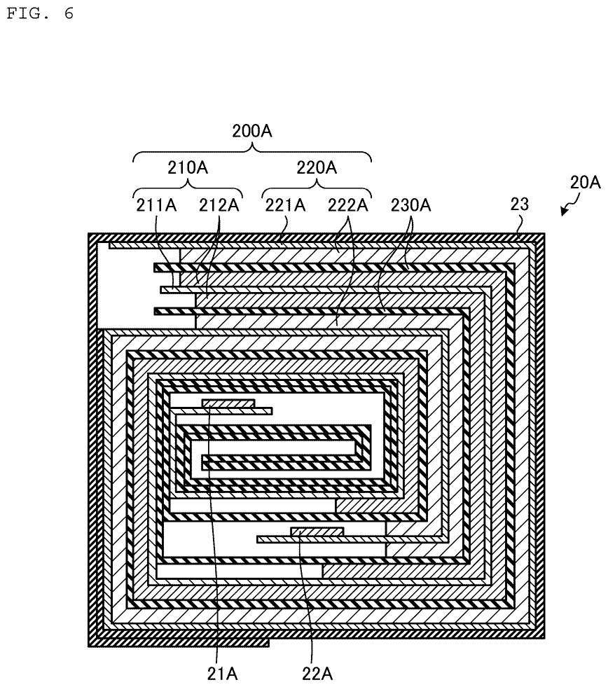

FIG. 5 is a cutaway view illustrating another example of the secondary battery according to the first embodiment. FIG. 6 is a schematic sectional view taken along line VI-VI in FIG. 5. A secondary battery 1A illustrated in FIGS. 5 and 6 is different from the example according to FIG. 1 in that the secondary battery has a structure in which the electrode assembly 200 is wound around a positive electrode lead 21A and a negative electrode lead 22A.

A battery element 20A is provided inside the exterior member 30. As shown in FIG. 6, the battery element 20A includes an electrode assembly 200A, the positive electrode lead 21A, the negative electrode lead 22A, and a protective member 23. The positive electrode lead 21A is a terminal extended from the inside of the battery element 20A to the outside of the exterior member 30, and the positive electrode lead 21A is provided near the center of the battery element 20A. The negative electrode lead 22A is a terminal extended from the inside of the battery element 20A to the outside of the exterior member 30, and the negative electrode lead 22A is provided near the center of the battery element 20A. The protective member 23 is a member that protects the exterior of the battery element 20A. The protective member 23 is provided so as to be wound around the electrode assembly 200A. The protective member 23 is, for example, an insulator tape.

In the example of FIG. 6, the electrode assembly 200A is a laminate for the charge-discharge reaction of the secondary battery 1A according to the first embodiment. The electrode assembly 200A includes: a positive electrode 210A including a positive electrode current collector 211A and positive electrode active material layers 212A; a negative electrode 220A including a negative electrode current collector 221A and negative electrode active material layers 222A; and a separator 230A. The electrode assembly 200A has a structure in which the electrode assembly is wound around the positive electrode lead 21A and the negative electrode lead 22A, and the negative electrode current collector 221A, the negative electrode active material layer 222A, the separator 230A, the positive electrode active material layer 212A, the positive electrode current collector 211A, the positive electrode active material layer 212A, the separator 230A, and the negative electrode active material layer 222A are stacked in this order from the outside, namely, from the protective member 23 side. In the electrode assembly 200A, no layer other than the negative electrode current collector 221A, the separator 230A, and the positive electrode current collector 211A is provided in the vicinity of the positive electrode lead 21A and the negative electrode lead 22A. With this structure, the positive electrode current collector 211A is connected to the positive electrode lead 21A, and the negative electrode current collector 221A is connected to the negative electrode lead 22A.

The electrolyte of the secondary battery according to the first embodiment may be an all-solid-state battery. That is, the electrolyte of the secondary battery according to the first embodiment may be a sintered body containing a solid electrolyte. Even in this case, the diffusion rate of lithium ions can be improved, and the charge-discharge load characteristics can be improved.

As described above, the positive electrode active material according to the first embodiment contains a lithium complex oxide having a layered rock-salt structure. The lithium complex oxide contains lithium, a metal element containing at least one of cobalt and nickel, and potassium. A ratio of a substance amount of potassium contained in the lithium complex oxide to a substance amount of the metal element contained in the lithium complex oxide is 0.0005 or more and 0.03 or less. In the lithium complex oxide, potassium is distributed so as to extend in a direction intersecting a <001> direction of the layered rock-salt structure. Thus, the diffusion rate of lithium ions can be improved, and the charge-discharge load characteristics can be improved.

As a desirable aspect, the lithium complex oxide has a composition formula represented by Li₁₋ₓKₓNi_{1-y}Co_{y}O_{2-z}, and satisfies 0.0005≤≤0.03, 0≤y≤1, and −0.1≤z≤0.2. Thus, since the amount of potassium becomes sufficient, the charge-discharge load characteristics can be further improved.

The positive electrode 210 according to the first embodiment contains the positive electrode active material according to the first embodiment. Thus, the charge-discharge load characteristics can be improved.

The secondary battery 1 according to the first embodiment includes the positive electrode 210 according to the first embodiment, the negative electrode 220, and an electrolyte. Thus, the charge-discharge load characteristics can be improved.

An example of a method for producing the positive electrode active material according to the first embodiment will be described below. The method for producing the positive electrode active material according to the first embodiment includes a firing step.

The firing step is a step of firing a precursor containing lithium, at least one of cobalt and nickel, and potassium to prepare a lithium complex oxide. The precursor is prepared, for example, by mixing lithium hydroxide, cobalt oxide or nickel oxide, and potassium hydroxide. In the first embodiment, the precursor is fired in a dry argon stream to once form a molten salt, and then cooled to obtain a fired product. Thereafter, the obtained fired product is pulverized, sieved with a particle size, and washed with a polar solvent to remove a precursor residue. Thus, the positive electrode active material according to the present embodiment is obtained.

Here, firing of the precursor is performed at 200° C. or higher and lower than 600° C. As a result, potassium is prevented from being dispersed in the crystal and is easily disposed in a direction intersecting the <001> direction of the layered rock-salt structure, so that the diffusion rate of lithium ions can be improved and the charge-discharge load characteristics can be improved.

Note that the method for producing the positive electrode active material according to the present embodiment is merely an example, and is not limited to the method described above. For example, the method for preparing a lithium complex oxide in the firing step is not limited to the molten salt crystallization method described above, and a crystal synthesis method that can be performed at lower than 600° C., such as a flux synthesis method, a laser thin film deposition method, a sputtering thin film deposition method, a chemical vapor deposition method, an organometallic decomposition method, a solvothermal synthesis method, or a soft chemical synthesis method, may be used.

As described above, the method for producing a positive electrode active material according to the present embodiment is a method for producing a positive electrode active material, the positive electrode active material containing a lithium complex oxide having a layered rock-salt structure, the method including: a step of firing a precursor containing lithium, at least one of cobalt and nickel, and potassium at 200° C. or higher and lower than 600° C. to prepare the lithium complex oxide. As a result, potassium is prevented from being dispersed in the crystal and is easily disposed in a direction intersecting the <001> direction of the layered rock-salt structure, so that the diffusion rate of lithium ions can be improved and the charge-discharge load characteristics can be improved.

### EXAMPLES

Examples will be described below according to an embodiment. Table 1 is a table indicating Examples and Comparative Examples. Note that the present disclosure is not limited thereby.

TABLE 1

| | | | Lithium complex oxide | | | | | | |
|---|---|---|---|---|---|---|---|---|---|
| | Firing step | | | K | Particle | Charge | Initial | Discharge | Charge |
| | Temperature | | | distribution | size | capacity | efficiency | load | load |
| | (° C.) | Atmosphere | X | state | (μm) | (mAh/g) | (%) | (%) | (%) |
| Example 1 | 350 | Argon | 0.03 | A | 10 | 171 | 94.3 | 96.3 | 94.5 |
| Example 2 | 350 | Argon | 0.03 | A | 10 | 179 | 93.1 | 90.7 | 75.6 |
| Example 3 | 350 | Argon | 0.005 | A | 20 | 182 | 92.7 | 88.9 | 74.6 |
| Example 4 | 350 | Argon | 0.0005 | A | 50 | 188 | 92.1 | 73.1 | 53.3 |
| Comparative | 850 | Air | 0 | — | 20 | 187 | 96.2 | 85.6 | 58.8 |
| Example 1 | | | | | | | | | |
| Comparative | 850 | Air | 0.001 | B | 20 | 182 | 93.5 | 82.1 | 54.5 |
| Example 2 | | | | | | | | | |

### Example 1

The positive electrode active material according to Example 1 was prepared by the following method. Lithium hydroxide, cobalt oxide, and potassium hydroxide were mixed to prepare a precursor, and as the firing step, the prepared precursor was put in a platinum crucible, fired by being held at 350° C. for 3 hours in a dry argon stream, and then cooled to obtain a fired product. The obtained fired product was pulverized, sieved with a particle diameter, and then washed with a polar solvent to remove a residue of the precursor. Thus, a positive electrode active material according to Example 1 was obtained. The particle size of the positive electrode active material according to Example 1 was 10 μm.

In a battery according to Example 1, the positive electrode housed in an exterior cup and the negative electrode housed in an exterior can are stacked with the separator interposed therebetween. In the battery according to Example 1, the exterior can and the exterior cup are swaged with a gasket. The separator according to Example 1 is impregnated with an electrolytic solution.

The positive electrode according to Example 1 was prepared by the following method. First, 98 parts by mass of the positive electrode active material prepared above, 1.2 parts by mass of polyvinylidene fluoride as a positive electrode binder, and 0.8 parts by mass of ketjen black as a positive electrode conductive aid were mixed to obtain a positive electrode mixture. Then, the prepared positive electrode mixture was dispersed in N-methyl-2-pyrrolidone to obtain a paste-like positive electrode mixture slurry. Subsequently, both surfaces of an aluminum foil having a thickness of 15 μm as a positive electrode current collector layer were coated with the positive electrode mixture slurry with use of a coating apparatus, and then, the positive electrode mixture slurry was dried with hot air to form a positive electrode active material layer on the positive electrode current collector layer. Thereafter, the positive electrode active material layer was compression-molded using a hydraulic press machine to obtain a positive electrode according to Example 1.

The negative electrode according to Example 1 was prepared by the following method. First, 95 parts by mass of graphite as a negative electrode active material and 5 parts by mass of polyvinylidene fluoride as a negative electrode binder were mixed to prepare a negative electrode mixture. Then, the prepared negative electrode mixture was dispersed in N-methyl-2-pyrrolidone to obtain a paste-like negative electrode mixture slurry. Subsequently, both surfaces of a copper foil having a thickness of 12 μm as a negative electrode current collector layer were coated with the negative electrode mixture slurry with use of a coating apparatus, and then, the negative electrode mixture slurry was dried with hot air to form a negative electrode active material layer on the negative electrode current collector layer. Thereafter, the negative electrode active material layer was compression-molded using a hydraulic press machine to obtain a negative electrode according to Example 1.

The negative electrode according to Example 1 was prepared by the following method. Lithium hexafluorophosphate as an electrolyte salt was dissolved in a liquid obtained by mixing ethylene carbonate and propylene carbonate at a volume ratio of 1:1 as a solvent. Here, the electrolytic solution was prepared so that the content of the electrolytic solution salt with respect to the solvent was 1 mol/cm³.

The battery according to Example 1 was assembled by the following method. First, the prepared positive electrode was punched into a pellet shape having a diameter of 15 mm, and housed inside an exterior cup. Then, the produced negative electrode was punched into a pellet shape having a diameter of 16 mm and housed inside the exterior can. Subsequently, a porous polyolefin film as a separator was impregnated with the prepared electrolytic solution, and was stacked between the positive electrode housed in the exterior can cup and the negative electrode housed in the exterior can. Thereafter, the exterior can and the exterior cup were swaged with a gasket. Thus, the battery according to Example 1 was prepared.

### <<Analysis of Positive Electrode Active Material>>

The prepared positive electrode active material was subjected to composition analysis using EDX. In the analysis, by using SEM-EDX (S-4800, Hitachi High-Technologies Corporation), a rectangular region having a length of 500 nm and a width of 500 nm, which was a region separated inward by 150 nm or more from the surface of the particles of the positive electrode active material in the positive electrode active material layer, was selected, and the contents of Co and K were measured. In the measurement, the contents of Co and K were measured in five regions not overlapping each other, and the molar ratio of the content of K to the content of Co in each region was calculated. Thus, the arithmetic average of the molar ratio of the content of K to the content of Co in each region was calculated to calculate x as the ratio of the substance amount of K to the substance amount of Co. As a result of the above measurement, in Example 1, x was 0.03. Here, in Example 1, since nickel is not contained, y is 1. In Example 1, z was 0.

For the prepared positive electrode active material, the crystal structure of the positive electrode active material was analyzed by a TEM. In the analysis, the crystal structure of the lithium complex oxide was measured by performing crystal structure analysis at a measurement point separated inward by 150 nm or more from the surface of the positive electrode active material particles of the positive electrode active material layer at an accelerating voltage of 200 kV using JEM-F200 (JEOL Ltd.). As a result of the above measurement, in Example 1, the crystal structure belonging to the space group R-3m could be confirmed at the measurement point. As a result, it was determined that the positive electrode active material according to Example 1 had a layered rock-salt structure.

For the prepared positive electrode active material, the distribution of potassium in the layered rock-salt structure was measured by TEM-EDX. In the measurement, by using a TEM (JEM-F200, JEOL Ltd.) and an attached EDX analyzer (Noran system 7, Thermo Fisher Scientific), a rectangular region having a length of 500 nm and a width of 500 nm, which was a region separated inward by 150 nm or more from the surface of the lithium complex oxide, was selected at an accelerating voltage of 200 kV, and the <001> direction of the layered rock-salt structure was specified by the analysis of the crystal orientation using the TEM. Next, an EDX mapping image of potassium was acquired in the region, and a region in which potassium was distributed was specified. As a result of the above measurement, in Example 1, as shown in FIG. 3B, the distribution of potassium was linear, and extended in the direction intersecting the <001> direction of the layered rock-salt structure. Thus, in Example 1, it was determined that potassium was distributed so as to extend in the direction intersecting the <001> direction of the layered rock-salt structure. In Table 1, when potassium was distributed so as to extend in the direction intersecting the <001> direction of the layered rock-salt structure, the K distribution state was regarded as “A”.

### <<Charge Capacity Measurement Test>>

The prepared battery was subjected to a charge test under the following conditions, and the electric capacity per unit mass of the positive electrode active material was calculated as a charge capacity.
Charging method: CC/CV charging
Charging rate: 0.05 C
Upper limit voltage: 4.3 V

### <<Initial Efficiency Measurement Test>>

The prepared battery was subjected to a charge-discharge test under the following conditions, the electric capacity per unit mass of the positive electrode active material during charging was defined as a charge capacity, the electric capacity per unit mass of the positive electrode active material during subsequent discharging was defined as a discharge capacity, and the ratio of the discharge capacity to the charge capacity was calculated as an initial efficiency.
Charging method: CC/CV charging
Charging rate: 0.05 C
Upper limit voltage: 4.3 V
Discharging method: CC discharging
Discharging rate: 0.05 C
Lower limit voltage: 3 V

### <<Discharge Load Measurement Test>>

The prepared battery was subjected to two discharge tests at different discharge rates under the following conditions, and the ratio of the electric capacity per unit mass of the positive electrode active material during discharging at a discharging rate of 0.2 C to the electric capacity per unit mass of the positive electrode active material during discharging at a discharging rate of 2 C was calculated as a discharge load.
Discharging method: CC discharging
Discharging rate: 2 C, 0.2 C
Lower limit voltage: 3 V

### <<Charge Load Measurement Test>>

The prepared battery was subjected to two charge tests at different charge rates under the following conditions, and the ratio of the electric capacity per unit mass of the positive electrode active material during charging at a charging rate of 0.2 C to the electric capacity per unit mass of the positive electrode active material during charging at a charging rate of 2 C was calculated as a charge load.
Charging method: CC discharging
Charging rate: 2 C, 0.2 C
Upper limit voltage: 3 V

### Example 2

In Example 2, a positive electrode active material and a battery were prepared in the same manner as in Example 1, and analysis and test were performed. As a result of analysis of the positive electrode active material, the composition, crystal structure, K distribution state, and particle size of the positive electrode active material according to Example 2 were the same as those in Example 1.

### Example 3

In Example 3, a positive electrode active material and a battery were prepared in the same manner as in Example 1 except that a positive electrode active material was prepared so that x was 0.005 and the particle size was 20 μm, and analysis and test were performed. As a result of analysis of the positive electrode active material, the crystal structure and K distribution state of the positive electrode active material according to Example 3 were the same as those in Example 1.

### Example 4

In Example 4, a positive electrode active material and a battery were prepared in the same manner as in Example 1 except that a positive electrode active material was prepared so that x was 0.0005 and the particle size was 50 μm, and analysis and test were performed. As a result of analysis of the positive electrode active material, the crystal structure and K distribution state of the positive electrode active material according to Example 4 were the same as those in Example 1.

### Comparative Example 1

A positive electrode active material according to Comparative Example 1 was prepared by the following method. Lithium carbonate and cobalt oxide were mixed to prepare a precursor, and as the firing step, the prepared precursor was put in an alumina crucible, fired by being held at 850° C. for 3 hours in a dry air stream, and then cooled to obtain a fired product. The obtained fired product was pulverized, sieved with a particle diameter, and then washed with a polar solvent to remove a residue of the precursor. Thus, a positive electrode active material according to Comparative Example 1 was obtained. Here, the particle size of the positive electrode active material according to Comparative Example 1 was 20 μm.

Thereafter, a battery was prepared in the same manner as in Example 1, and analysis and test were performed. As a result of analysis of the positive electrode active material, the crystal structure of the positive electrode active material according to Comparative Example 1 was the same as that in Example 1. On the other hand, as a result of measuring the distribution of potassium in the layered rock-salt structure by TEM-EDX, potassium was not distributed.

### Comparative Example 2

In Comparative Example 2, a positive electrode active material and a battery were prepared in the same manner as in Comparative Example 1 except that a positive electrode active material was prepared by further using potassium hydroxide as a raw material of the precursor so that x was 0.001, and analysis and test were performed. As a result of analysis, the crystal structure of the positive electrode active material according to Example 4 was the same as that in Example 1. On the other hand, as a result of measuring the distribution of potassium in the layered rock-salt structure by TEM-EDX, in Comparative Example 2, as shown in FIGS. 4A and 4B, potassium was dispersed in dotted form along the surface of the particles of the positive electrode active material, and the distribution of potassium was not linear. Thus, in Example 1, it was determined that potassium was not distributed so as to extend in the direction intersecting the <001> direction of the layered rock-salt structure. In Table 1, when potassium was dispersed in a dotted form and the distribution of potassium was not linear, the K distribution state was regarded as “B”.

As shown in Table 1, in Examples 1 to 3, since the K distribution state was “A”, the charge load and the discharge load were improved without largely decreasing the charge capacity and the initial efficiency, as compared with Comparative Example 1 not containing K and Comparative Example 2 having the K distribution state of “B”. Therefore, it is found that by setting the K distribution state to “A”, the charge-discharge load characteristics can be improved while suppressing a decrease in charge-discharge characteristics.

As shown in Table 1, in Example 4, by setting the K distribution state to “A” and setting the particle size to 50 μm, the charge capacity was improved without largely decreasing battery characteristics such as an initial capacity, a charge load, and a charge load, as compared with Comparative Example 1 not containing K and having a particle size of 20 μm and Comparative Example 2 having the K distribution state of “B” and a particle size of 20 μm. Therefore, it is found that the charge capacity can be improved by increasing the particle size. It is also found that by setting the K distribution state to “A”, it is possible to suppress a significant decrease in charge-discharge load characteristics due to an increase in particle size.

The embodiment mentioned above is intended to facilitate understanding of the present disclosure, and is not intended to limit the present disclosure. The present disclosure can be modified or improved without departing from the present disclosure, and the present disclosure includes equivalents thereof.

### DESCRIPTION OF REFERENCE SYMBOLS

1, 1A: Secondary battery
20, 20A: Battery element
21, 21A: Positive electrode lead
22, 22A: Negative electrode lead
23: Protective member
30: Exterior member
30a, 30b: Exterior sheet
31: Recess
32: Adhesive member
200, 200A: Electrode assembly
210, 210A: Positive electrode
211, 211A: Positive electrode current collector
212, 212A: Positive electrode active material layer
220, 220A: Negative electrode
221, 221A: Negative electrode current collector
222, 222A: Negative electrode active material layer
230, 230A: Separator

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A positive electrode active material comprising:
a lithium complex oxide having a layered rock-salt structure, wherein
the lithium complex oxide includes lithium, a metal element including at least one of cobalt and nickel, and potassium,
a ratio of a substance amount of potassium included in the lithium complex oxide to a substance amount of the metal element included in the lithium complex oxide is 0.0005 or more and 0.03 or less, and
in the lithium complex oxide, potassium is distributed so as to extend in a direction intersecting a <001> direction of the layered rock-salt structure.

2. The positive electrode active material according to claim 1, wherein the lithium complex oxide has a composition formula represented by Li₁₋ₓKₓNi_{1-y}Co_{y}O_{2-z}, and satisfies 0.0005≤x≤0.03, 0≤y≤1, and −0.1≤z≤0.2.

3. A positive electrode comprising the positive electrode active material according to claim 1.

4. A secondary battery comprising:
the positive electrode according to claim 3;
a negative electrode; and
an electrolyte.

5. A method for producing a positive electrode active material, the positive electrode active material containing a lithium complex oxide having a layered rock-salt structure, the method comprising:
firing a precursor including lithium, at least one of cobalt and nickel, and potassium at 200° C. or higher and lower than 600° C. to prepare the lithium complex oxide.
